(19) United States
(12) Patent Application Publication
(10) Pub. No.: US 2007/0222925 A1
(43) Pub. Date: Sep. 27, 2007

(54) LIQUID CRYSTAL DISPLAY AND METHOD OF MANUFACTURING THE SAME

(76) Inventors: Dae-Jin Park, Incheon-si (KR); Hyung-Il Jeon, Incheon-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/689,891

(22) Filed: Mar. 22, 2007

(30) Foreign Application Priority Data
Mar. 24, 2006 (KR) 10-2006-0026947

(51) Int. Cl. G02F 1/1335

(52) U.S. Cl. 349/114

(57) ABSTRACT

A liquid crystal display that includes: a first substrate; a transparent electrode formed on the first substrate; a reflecting electrode that is formed on the transparent electrode and has openings exposing the transparent electrode therethrough and a plurality of removal portions; a second substrate facing the first substrate; and a common electrode formed on the second substrate.

### CROSS-REFERENCE TO RELATED APPLICATION

This application claims priority to and the benefit of Korean Patent Application No. 10-2006-0026947 filed in the Korean Intellectual Property Office on Mar. 24, 2006, the entire contents of which are incorporated herein by reference.

### BACKGROUND OF THE INVENTION

1. Field of the Invention

The present invention relates to a liquid crystal display (LCD) and a method of manufacturing the same.

2. Description of the Related Art

A liquid crystal display (LCD) is composed of two panels in which electrodes are formed and a liquid crystal layer that is interposed between the two panels. Voltage is applied to the electrodes to generate electric fields in the liquid crystal layer to variously orient the liquid crystal molecules in the liquid crystal layer thereby controlling the polarization of incident light so as to display an image.

A liquid crystal display may be classified as a transmissive liquid crystal display, a reflective liquid crystal display, or a transflective liquid crystal display according to a light source. The transmissive liquid crystal display displays an image using an internal light source such as a backlight located on the rear side of liquid crystal cells. The reflective liquid crystal display uses an external light source such as natural light. The transflective liquid crystal display has a combined structure of a transmissive liquid crystal display and a reflective liquid crystal display and includes a reflective area and a transmissive area.

The transflective liquid crystal display functions as a transmissive mode to display an image using a built-in light source of a display element in a room or a dark environment where an external light source does not exist, and functions as a reflective mode to display an image by reflecting external light in an outdoor high-illumination environment.

It is important for the transflective liquid crystal display to sustain an optimum state of the reflective mode and the transmissive mode according to ambient conditions.

However, the requirements for sustaining the optimum state of the reflective mode and transmissive mode in the transflective liquid crystal display conflict with each other. For example, if the reflective area is increased in size to optimize the reflective mode, the size of the transmissive area is decreased e, thereby degrading transmission efficiency. If the size of the transmissive area is increased to optimize the transmissive mode, the size of the reflective area relatively is decreased, thereby degrading reflection efficiency.

### SUMMARY OF THE INVENTION

According to one aspect of the present invention a transflective liquid crystal display having enhanced transmission efficiency without degrading reflection efficiency comprise: a first substrate; a transparent electrode formed on the first substrate; a reflecting electrode formed on the transparent electrode having openings exposing the transparent electrode and a plurality of removal portions; a second substrate facing the first substrate; and a common electrode formed on the second substrate. The transparent electrode may include a first concave portion, a second convex portion, and a third portion located between the first portion and the second portion, the removal portion being located on the third portion. The removal portion may have a width in the range of about 1 μm to 1.5 μm.

The interval between the adjacent removal portions may be indicated by the following Expression 1:

$$Y = \frac{m λ D}{d} \qquad ( 1 )$$

(where Y is an interval between the removal portions, m is a constant, λ is a wavelength, D is a cell gap, and d is the width of the removal portion). The liquid crystal display may further includes a first passivation layer formed below the transparent electrode, and the surface of the first passivation layer may be formed in an uneven shape to correspond to the first portion, the second portion, and the third portion. The first passivation layer may include organic material.

The liquid crystal display may further include a second passivation layer formed below the first passivation layer.

The liquid crystal display may further include a plurality of signal lines formed on the first substrate, and a plurality of thin film transistors that may be connected to the signal lines and the transparent electrode.

According to another embodiment of the present invention, a transflective liquid crystal display including a transmissive area and a reflective area includes a plurality of pixels including a first portion and a second portion. In the liquid crystal display, the first portion is a first transmissive area where a first transparent electrode is formed, and the second portion includes a reflective area including a second transparent electrode and a reflecting electrode formed on the second transparent electrode, and a second transmissive area in which a removal portion which is formed at the reflecting electrode and the second transparent electrode is exposed through the removal portion.

The second transparent electrode may include a first concave portion, a second convex portion, and a third portion located between the first portion and the second portion, and the removal portion may be located on the third portion.

The removal portion may have a width in the range of about 1 μm to 1.5 μm.

The interval between the adjacent removal portions may be indicated by the following Expression 1:

$$Y = \frac{m λ D}{d} \qquad ( 1 )$$

(where Y is the interval between the removal portions, m is a constant, λ is a wavelength, D is a cell gap, and d is the width of the removal portion).

The liquid crystal display may further include a first passivation layer formed below the first and second transparent electrodes, and the first passivation layer may be formed in an uneven shape to correspond to the first portion, the second portion, and the third portion.

The liquid crystal display may further include a second passivation layer formed below the first passivation layer.

According to another embodiment of the present invention, a method of manufacturing a liquid crystal display includes: forming gate lines on a substrate; sequentially forming a gate insulating layer and a semiconductor layer on the gate lines; forming data lines on the semiconductor layer; forming a first passivation layer on the data lines; forming a transparent electrode on the first passivation layer; forming a reflecting electrode on the transparent electrode; forming a photosensitive film on the reflecting electrode; disposing a printing plate having a plurality of protrusions above the photosensitive film; removing portions of the photosensitive film corresponding to the protrusions by imprinting the photosensitive film with the printing plate; and etching the reflecting electrode by using the photosensitive film as a mask.

The forming of the first passivation layer may include coating a photosensitive organic film, and forming the surface of the photosensitive organic film in an uneven shape having a first concave portion, a second convex portion, and a third portion located between the first portion and the second portion.

The protrusion of the printing plate may be located so as to correspond to the third portion of the first passivation layer. The protrusion of the printing plate may have a width in the range of about 1 μm to 1.5 μm.

The method may further include forming a second passivation layer before the forming of the first passivation layer.

The forming of the first passivation layer may include at least one of thermosetting and photo-curing the first passivation layer.

### BRIEF DESCRIPTION OF THE DRAWINGS

FIG. 1 is a layout of a liquid crystal display according to an embodiment of the present invention.

FIG. 2 is a cross-sectional view showing the liquid crystal display of FIG. 1 taken along the line II-II.

FIGS. 3 to 11 are views sequentially showing a method of manufacturing a liquid crystal display according to an embodiment of the present invention.

### DETAILED DESCRIPTION OF THE EMBODIMENTS

The present invention will be described more fully hereinafter with reference to the accompanying drawings, in which preferred embodiments of the invention are shown.

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

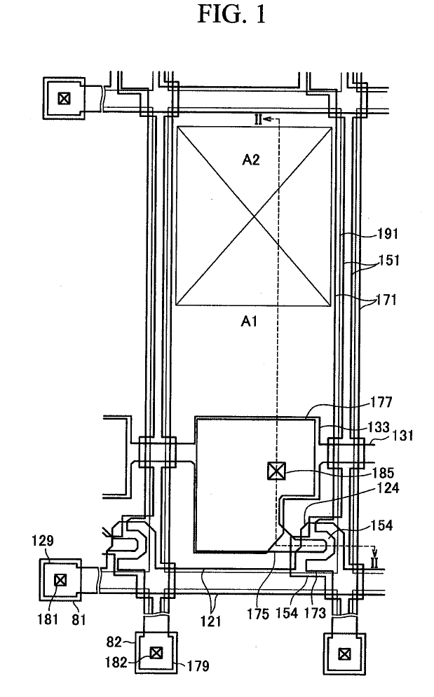

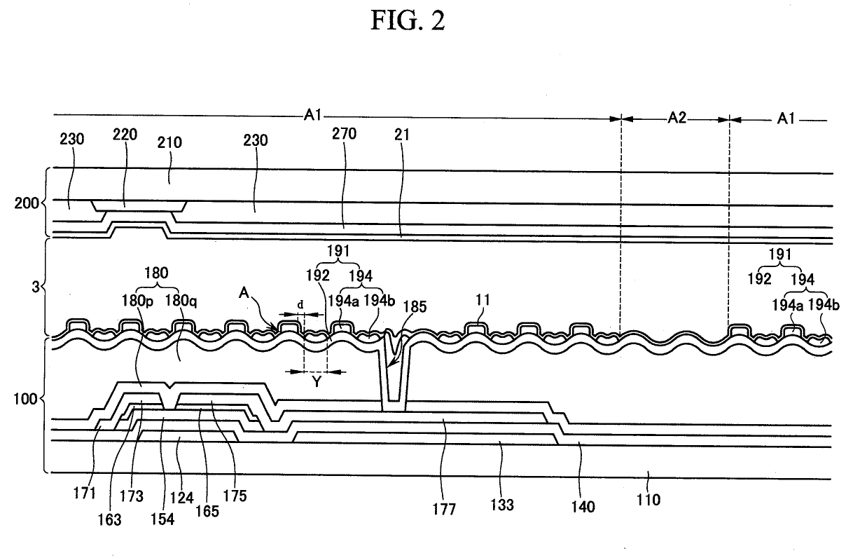

A liquid crystal display according to an embodiment of the present invention will now be described with reference to FIGS. 1 and 2.

FIG. 1 is a layout of a liquid crystal display according to an embodiment of the present invention, and FIG. 2 is a cross-sectional view showing the liquid crystal display of FIG. 1 taken along the line II-II.

As shown in FIGS. 1 and 2, the liquid crystal display according to the embodiment of the present invention includes a thin film transistor display panel 100, a common electrode display panel 200 facing the thin film transistor display panel 100, and a liquid crystal layer 3 interposed therebetween.

First, the thin film transistor display panel 100 will be described.

A plurality of gate lines 121 and a plurality of storage electrode lines 131 are formed on a substrate 110 made of transparent glass or plastic.

The gate line 121 transmits gate signals and extends mainly in a transverse direction. Each gate line 121 includes a plurality of gate electrodes 124 protruding upward and a wide end portion 129 provided for connection with other layers or an external driving circuit. A gate driving circuit (not shown) for generating gate signals may be mounted on a flexible printed circuit film (not shown) attached on the substrate 110, or may be directly mounted on the substrate 110 integrated onto the substrate 110. When the gate driving circuit is integrated into the substrate 110, the gate lines 121 may extend so as to be directly connected to the gate driving circuit 110.

A predetermined voltage is applied to the storage electrode lines 131 which extend substantially parallel to the gate lines 121. Each storage electrode line 131 is provided between two adjacent gate lines 121, and is closer to the lower one of the two adjacent gate lines 121. The storage electrode line 131 includes a plurality of storage electrodes 133 expanding upward and downward. However, the shape and arrangement of the storage electrode lines 131 may be modified in various ways.

The gate lines 121 and the storage electrode lines 131 may be made of an aluminum-containing metal such as aluminum (Al) or an aluminum alloy, a silver-containing metal such as silver (Ag) or a silver alloy, a copper-containing metal such as copper (Cu) or a copper alloy, a molybdenum-containing metal such as molybdenum (Mo) or a molybdenum alloy, or a low-resistance conductive material such as chromium (Cr), tantalum (Ta), or titanium (Ti). Each of the gate lines 121 and storage electrode lines 131 may also have a multilayer structure that includes two conductive layers (not shown) with different physical properties.

The side surfaces of the gate lines 121 and the storage electrode lines 131 may be inclined with respect to the substrate 110, and an angle of inclination between the side surface and the substrate may be in the range of about 30° to 80°.

A gate insulating layer 140 is made of, for example, silicon nitride (SiNₓ) or silicon oxide (SiO₂), on the gate lines 121 and the storage electrode lines 131.

A plurality of semiconductor stripes 151 are made of hydrogenated amorphous silicon (amorphous silicon is briefly referred to as “a-Si”) or polysilicon on the gate insulating layer 140. Each of the semiconductor stripes 151 extends substantially in a vertical direction, and includes a plurality of projections 154 protruding toward the gate electrodes 124. Each of the semiconductor stripes 151 has a large width in the vicinity of the gate lines 121 and the storage electrode lines 131 so as to cover the gate lines 121 and the storage electrode lines 131.

A plurality of ohmic contact stripes and islands 161 and 165 are formed on the semiconductor stripes 151. The ohmic contact stripes and islands 161 and 165 may be made of n+ hydrogenated a-Si in which n-type impurities such as phosphorus (P) are doped at a high concentration, or silicide. The ohmic contact stripes 161 include a plurality of protrusions 163, and the protrusions 163 and the ohmic contact islands 165 are provided in pairs on the projections 154 of the semiconductor stripes 151.

The side surfaces of the semiconductor stripes 151 and the ohmic contact stripes and islands 161 and 165 may be inclined with respect to the substrate 110, and an angle of inclination between the side surface and the substrate 110 is in the range of about 30° to 80°.

A plurality of data lines 171 and a plurality of drain electrodes 175 that are separated from the data lines 171 are formed on the ohmic contact stripes and islands 161 and 165 and the gate insulating layer 140.

The data lines 171 transmit data signals, and extend substantially in a vertical direction so as to cross the gate lines 121. Each of the data lines 171 includes a plurality of source electrodes 173 extending toward the gate electrodes 124 and an end portion 179 having a large area so as to be connected to another layer or an external driving circuit. A data driving circuit (not shown) for generating data signals may be mounted on a flexible printed circuit film (not shown) attached on the substrate 110, may be directly mounted on the substrate 110, or may be integrated onto the substrate 110. When the data driving circuit is integrated onto the substrate 110, the data lines 171 may extend so as to be directly connected to the data driving circuit.

The drain electrodes 175 are separated from the data lines 171, and face the source electrodes 173 on the gate electrodes 124. Each of the drain electrodes 175 includes one end portion 177 having a large width and the other end portion having a bar shape. The end portion 177 of the drain electrode 175 having a large width overlaps the storage electrode 133, and the other end portion having a bar shape is partially surrounded by the bent source electrodes 173.

A gate electrode 124, a source electrode 173, a drain electrode 175, and a projection 154 of the semiconductor stripes 151 form a thin film transistor (TFT), and a channel of the thin film transistor is formed in the projection 154 between the source electrode 173 and the drain electrode 175.

The data lines 171 and the drain electrodes 175 may be made of low-resistance conductive materials in the same manner as the gate lines 121.

The side surfaces of the data lines 171 and the drain electrodes 175 may be inclined with respect to the substrate 110, and an angle of inclination between the side surface and the substrate may be in the range of about 30° to 80°.

The ohmic contact stripes and islands 161 and 165 are provided only between the semiconductor stripes 151 and the data lines 171 and drain electrodes 175. In addition, the ohmic contact stripes and islands 161 and 165 lower the contact resistance between the semiconductor stripes 151 and the data lines 171 and drain electrodes 175. The semiconductor stripes 151 are narrower than the data lines 171 at most positions. However, as described above, the semiconductor stripes 151 have large widths at the intersections with the gate lines 121 and the storage electrode lines 131 so as to have smooth surface profiles. Accordingly, it is possible to prevent the data lines 171 from being disconnected. The projections 154 of the semiconductor stripes 151 have portions not covered with the data lines 171 and the drain electrodes 175 so as to be exposed to the outside, as well as portions between the source electrodes 173 and the drain electrodes 175.

A passivation layer 180 is formed on the data lines 171, the drain electrodes 175, and the portions of the projections 154 exposed to the outside. The passivation layer 180 includes a lower passivation layer 180p and an upper passivation layer 180q.

The lower passivation layer 180p may be made of an inorganic insulating material such as SiNₓ or SiO₂, and improves the adhesive property between the data lines 171 and drain electrodes 175 and the upper passivation layer 180q.

The upper passivation layer 180q may be made of an organic material having photosensitivity, and the surface thereof is embossed to be uneven.

The passivation layer 180 has a plurality of contact holes 182 and 185 that expose the end portions 179 of the data lines 171 and the drain electrodes 175, respectively. Furthermore, each of the passivation layer 180 and the gate insulating layer 140 has a plurality of contact holes 181 that expose the end portions 129 of the gate lines 121.

A plurality of pixel electrodes 191 and a plurality of contact assistants 81 and 82 are formed on the passivation layer 180.

Each of the pixel electrodes 191 includes a transparent electrode 192 and a reflecting electrode 194 formed on the transparent electrode 192. The transparent electrode 192 may be made of a transparent conductive material such as indium tin oxide (ITO) or indium zinc oxide (IZO), and the reflecting electrode 194 may be made of a reflective conductive material such as Al, Ag, Cr, or alloys thereof.

The pixel electrode 191 may further include a contact assistant layer (not shown) made of such as Mo, Cr, Ti, Ta, or alloys thereof. The contact assistant layer ensures the adhesive property of the transparent electrode 192 and the reflecting electrode 194, and prevents the reflecting electrode 194 from being oxidized by the transparent electrode 192.

The transparent electrode 192 is formed along the surface of the upper passivation layer 180q so as to have an uneven shape including convex portions and concave portions.

The reflecting electrode 194 exists only on some portions on the transparent electrode 192, and is removed at the rest of the portions to form a plurality of the removal portions A. The reflecting electrode 194 is formed along the surface of the transparent electrode 192, thereby having convex and concave portions in the same manner as the transparent electrode 192.

The reflecting electrode 194 includes a first reflecting electrodes 194a formed on the convex portions and a second reflecting electrodes 194b formed in the concave portions. A removal portion A is positioned between the first reflecting electrode 194a and the second reflecting electrode 194b so as to separate them.

The removal portion A is a slit having a width d in the range of about 1 μm to 1.5 μm, and the removal portions A are disposed at an interval Y satisfying the following Expression 1:

$$Y = \frac{m λ D}{d} \qquad ( 1 )$$

(where Y is the interval between the removal portions A, m is a constant, λ is a wavelength of light, d is the width of the removal portion A, and D is a cell gap).

Expression 1 indicates an interval between the removal portions A that does not obstruct but conducts light components coming from a light source such as a backlight when the light components pass through the removal portions A.

In the transflective liquid crystal display, one pixel may be divided into a reflective area and a transmissive area according to whether the reflecting electrode 194 exists or not. The reflective area is defined by the presence of the reflecting electrode 194, and the transmissive area is defined by the area where the reflecting electrode 194 is removed or not present so that the transparent electrode 192 below the removed portion of electrode 194 is exposed.

In the liquid crystal display according to the embodiment of the present invention, one pixel may be divided into a first area A1 and a second area A2.

The first area A2 is the transmissive area where the reflecting electrode 194 is removed and thus the transparent electrode 192 therebelow is exposed. Therefore, in the first area A2, light from the rear surface of the liquid crystal display, that is, a light source such as a backlight disposed at the thin film transistor display panel 100 passes through the liquid crystal layer 3, and travels toward the common electrode display panel 200, thereby performing display.

The second area A1 includes the reflective area in which the reflecting electrodes 194 are formed and the transmissive area in which the removal portions A are interposed between the first reflecting electrodes 194a and the second reflecting electrodes 194b. In the second area A1, light from the common electrode panel 200 travels to the liquid crystal layer 3, and is then reflected by the reflecting electrode 194. After that, the light passes through the liquid crystal layer 3 again and travels to the common electrode panel 200, thereby performing display. In this case, the embossed surface of the reflecting electrode 194 causes light to be diffusely reflected, thereby preventing an object from being reflected in a screen. In the transmissive area, display is performed by the same method as that of the first area A2.

As described above, the liquid crystal display according to the embodiment of the present invention includes the first area A2 that is the transmissive area, and the second area A1 that includes both the reflective area and transmissive area.

As described above, the removal portion A is located between the first reflecting electrode 194a and the second reflecting electrode 194b. The first reflecting electrode 194a and the second reflecting electrode 194b are formed in such positions that vertically reflect light incident on the substrate, and accordingly reflection efficiency is high. On the contrary, reflection efficiency is low between the first reflecting electrode 194a and the second reflecting electrode 194b positioned at an angle with respect to the light incident on the substrate. Therefore, according to the embodiment of the present invention, the reflecting electrodes formed in positions where reflection efficiency is not high are removed so as to form a transmissive area, thereby improving transmission efficiency. Therefore, it is possible to improve transmission efficiency while keeping reflection efficiency from being degraded.

The pixel electrode 191 and one end portion 177 of the drain electrode 175 that is electrically connected to the pixel electrode 191 overlap the storage electrode line 131. The pixel electrode 191 and one end portion 177 of the drain electrode 175 overlap the storage electrode line 131 so as to form a capacitor. The capacitor is referred to as a storage capacitor, and the storage capacitor improves the voltage holding performance of the liquid crystal capacitor.

The contact assistants 81 and 82 are connected to the end portion 129 of the gate line 121 and the end portion 179 of the data line 171 through the contact holes 181 and 182, respectively. The contact assistants 81 and 82 improve the adhesive property between the end portion 129 of the gate line 121 and an external device, and between the end portion 179 of the data line 171 and an external device. Further, the contact assistants 81 and 82 protect the end portion 129 of the gate line 121 and the end portion 179 of the data line 171.

Hereinafter, the common electrode display panel 200 will be described.

A light blocking member 220 is formed on a substrate 210 made of an insulating material, for example transparent glass or plastic. The light blocking member 220 is also called a black matrix, and prevents light from leaking between the pixel electrodes 191.

A plurality of color filters 230 are formed on the substrate 210. The color filters 230 are arrayed in strip shapes along the pixel electrodes 191 in a vertical direction. Each of the color filters 230 can display one of three primary colors of red, green, and blue.

A common electrode 270 is formed of a transparent conductive material such as ITO or IZO on the color filters 230 and the light blocking member 220.

Alignment layers 11 and 21 are formed on the inner surfaces of the display panels 100 and 200, respectively.

A method of manufacturing the liquid crystal display according to the embodiment of the present invention will now be described with reference to FIGS. 3 to 11 and FIG. 1.

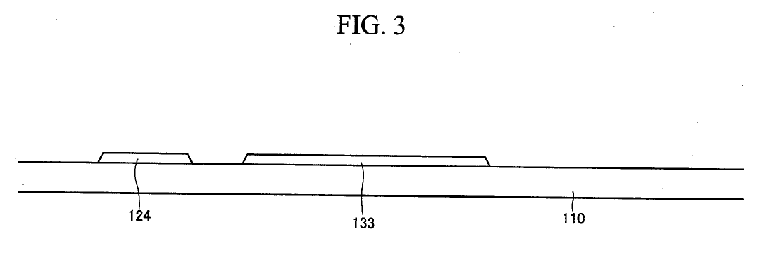

FIGS. 3 to 11 are cross-sectional views sequentially showing the method of manufacturing the liquid crystal display according to the embodiment of the present invention.

First, as shown in FIG. 3, a metallic layer is formed on the insulating substrate 110 and then etched through photolithography, thereby forming the gate line 121 including the gate electrode 124 and the end portion 129, and the storage electrode line 131 including the storage electrodes 133.

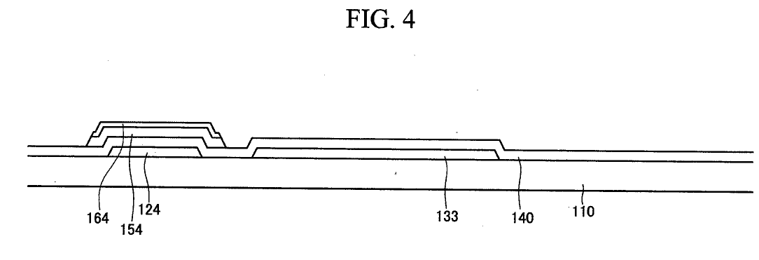

Next, as shown in FIG. 4, the gate insulating layer 140, an intrinsic a-Si layer, and an impurity a-Si layer are sequentially formed on the gate line 121, the storage electrode line 131 and the insulating substrate 110, and the intrinsic a-Si layer and the impurity a-Si layer are etched through photolithography, thereby forming a plurality of impurity semiconductors 164 and a plurality of semiconductor stripes 151 including projections 154.

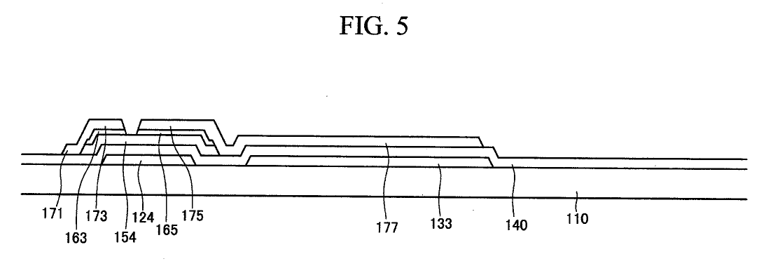

Next, as shown in FIG. 5, a metallic layer is formed on the gate insulating layer 140 and the impurity semiconductor 164 and etched through photolithography, thereby forming the data lines 171 including source electrodes 173 and the drain electrodes 175 including the end portion 177 having a large area.

Next, the impurity semiconductor 164 is dry etched by using the data lines 171 and the drain electrodes 175 as masks so as to be divided into the ohmic contact stripes 161 including the protrusions 163 and the ohmic contact islands 165 and to expose the projections 154 of the semiconductor stripes 151.

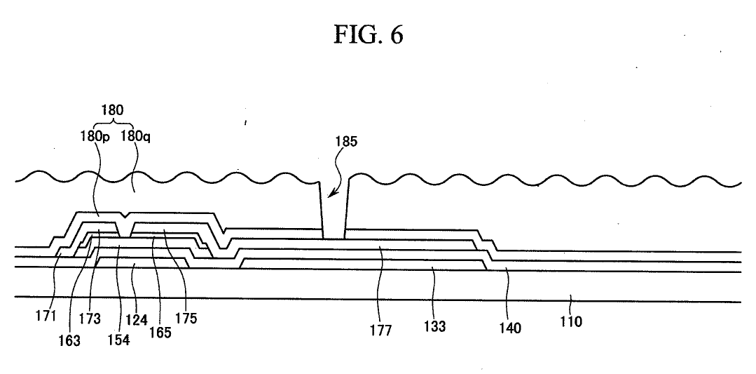

Next, as shown in FIG. 6, SiNₓ or SiO₂ is deposited on the data lines 171, the drain electrodes 175, and the exposed projections 154 of the semiconductor stripes 151 by plasma enhanced chemical vapor deposition (PECVD), thereby laminating the lower passivation layer 180p thereon.

Subsequently, a photosensitive organic material is applied on the lower passivation layer 180p, a mask having a slit pattern is disposed thereon, and then exposing is performed, thereby forming the upper passivation layer 180q having an uneven surface and the plurality of contact holes 181, 182, and 185.

Subsequently, contact holes are formed through the lower passivation layer 180p by using the upper passivation layer 180q as a mask, thereby exposing the end portions 129 of the gate lines 121, the end portions 179 of the data lines 171, and the drain electrodes 175.

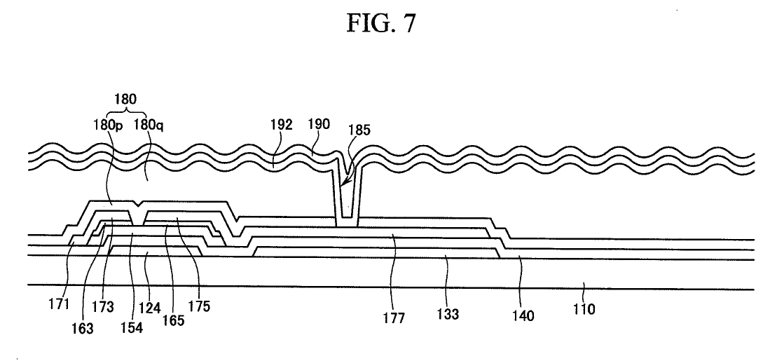

Next, as shown in FIG. 7, the transparent electrode 192 made of ITO or IZO and the reflecting electrode layer 190 made of a non-transparent material such as Al are sequentially formed on the upper passivation layer 180q. Here, the transparent electrode 192 and the reflecting electrode layer 190 are formed in an uneven shape along the embossed surface of the upper passivation layer 180q.

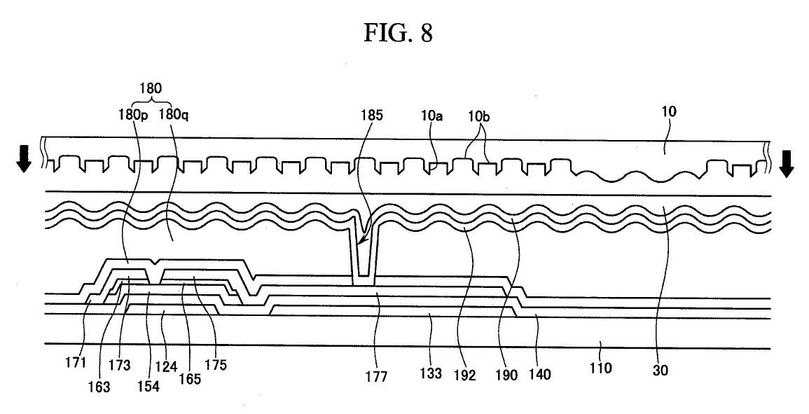

Next, as shown in FIG. 8, a photosensitive film 30 is coated on the reflecting electrode layer 190.

Subsequently, a printing plate 10 for imprinting is disposed above the photosensitive film 30. The printing plate 10 has a first flat surface and a second surface including a plurality of protrusions 10a. The first flat surface can be evenly pressed because of the flatness, and the second surface includes the plurality of protrusions 10a and a plurality of flat portions 10b located between the adjacent protrusions 10a, so that a predetermined pattern can be formed in a desired position of the photosensitive film 30. The printing plate 10 can be manufactured by using a laser.

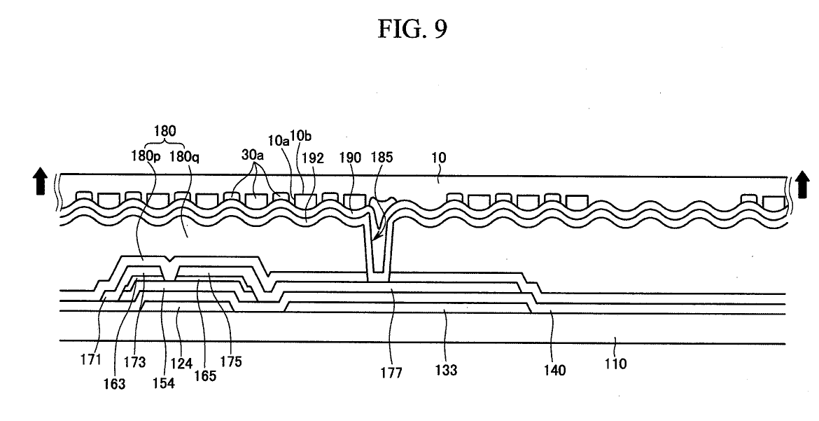

Subsequently, the printing plate 10 is imprinted on the photosensitive film 30. Accordingly, as shown in FIG. 9, portions of the photosensitive film 30 that are imprinted by the protrusions 10a of the printing plate 10 are removed, and portions of the photosensitive film 30 that are imprinted by the flat portions 10b of the printing plate 10 remain as a photosensitive film pattern 30a.

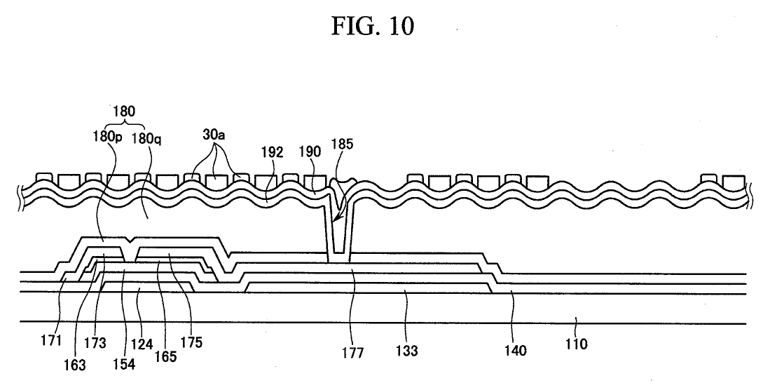

Subsequently, as the printing plate 10 is removed, as shown in FIG. 10, a plurality of photosensitive film patterns 30a remain on the reflecting electrode layer 190.

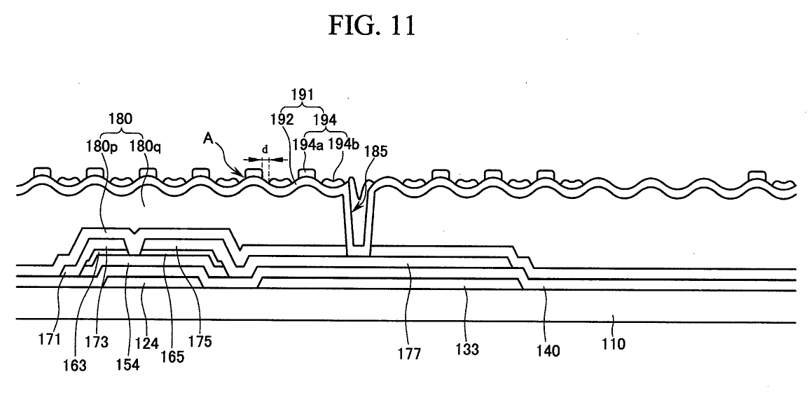

Next, as shown in FIG. 11, the reflecting electrode layer 190 is etched by using the photosensitive film pattern 30a as a mask, thereby forming the plurality of first reflecting electrodes 194a and the plurality of second reflecting electrodes 194b. Portions between the first reflecting electrodes 194a and the second reflecting electrodes 194b are imprinted by the protrusions 10a of the printing plate 10 and etched through portions where the photosensitive film 30 is removed, and the reflecting electrode layer 190 is removed to form the removal portion A.

Next, as shown in FIGS. 1 and 2, an alignment layer is formed on the first and the second reflecting electrodes 194a and 194b, thereby completing the formation of the thin film transistor display panel 100.

On the other hand, in the common electrode display panel 200, the plurality of light blocking members 220 are formed at intervals on the insulating substrate 210 and then the color filters 230 are formed in areas surrounded by the light blocking members 220. Next, the common electrode 270 is formed of ITO or IZO on the light blocking members 220 and the color filters 230, and the alignment layer 21 is formed thereon.

Subsequently, the thin film transistor display panel 100 and the common electrode display panel 200, which are manufactured as described above, are assembled, and liquid crystal is injected between the thin film transistor display panel 100 and the common electrode display panel 200.

As described above, in the method of manufacturing the liquid crystal display according to the embodiment of the present invention, the photosensitive film is imprinted by using the printing plate having a predetermined pattern, thereby patterning the reflecting electrode. When the photosensitive film formed on the uneven surface is patterned by exposure, it is difficult to form a desired photosensitive film pattern due to an exposure sensitivity difference. However, when the photosensitive film is imprinted as described above, reflecting electrodes of a desired pattern can be easily obtained.

Also, it is possible to enhance luminance by improving transmission efficiency without degrading reflection efficiency in the transflective liquid crystal display.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a first substrate;
a transparent electrode formed on the first substrate;
a reflecting electrode that is formed on the transparent electrode and has openings exposing the transparent electrode therethrough and a plurality of removal portions;
a second substrate facing the first substrate; and
a common electrode formed on the second substrate
wherein the transparent electrode includes a first concave portion, a second convex portion, and a third portion located between the first portion and the second portion, and
the removal portion is located on the third portion.

2. The liquid crystal display of claim 1, wherein the removal portion has a width in the range of about 1 μm to 1.5 μm.

3. The liquid crystal display of claim 1, wherein the interval between the adjacent removal portions is indicated by the following Expression 1:
$$Y = \frac{m λ D}{d} \qquad ( 1 )$$
(where m is a constant, λ is a wavelength, D is a cell gap, and d is the width of the removal portion).

4. The liquid crystal display of claim 1, further comprising a first passivation layer formed below the transparent electrode,
wherein the surface of the first passivation layer is formed in an uneven shape to correspond to the first portion, the second portion, and the third portion.

5. The liquid crystal display of claim 4, wherein the first passivation layer comprises organic material.

6. The liquid crystal display of claim 4, further comprising a second passivation layer formed below the first passivation layer.

7. The liquid crystal display of claim 1, further comprising:
a plurality of signal lines formed on the first substrate; and
a plurality of thin film transistors that are connected to the signal lines and the transparent electrode.

8. A transflective liquid crystal display including a transmissive area and a reflective area, the liquid crystal display comprising
a plurality of pixels including a first portion and a second portion,
wherein the first portion is a first transmissive area where a first transparent electrode is formed, and
the second portion comprises a reflective area including a second transparent electrode and a reflecting electrode formed on the second transparent electrode, and a second transmissive area in which a removal portion is formed in the reflecting electrode to expose the second transparent electrode through the removal portion
wherein the second transparent electrode includes a first concave portion, a second convex portion, and a third portion located between the first portion and the second portion, and the removal portion is located on the third portion.

9. The liquid crystal display of claim 8, wherein the removal portion has a width in the range of about 1 μm to 1.5 μm.

10. The liquid crystal display of claim 8, wherein the interval between the adjacent removal portions is indicated by the following Expression 1:
$$Y = \frac{m λ D}{d} \qquad ( 1 )$$
(where m is a constant, λ is a wavelength, D is a cell gap, and d is the width of the removal portion).

11. The liquid crystal display of claim 8, further comprising a first passivation layer formed below the first and second transparent electrodes, wherein the first passivation layer is formed in an uneven shape to correspond to the first portion, the second portion, and the third portion.

12. The liquid crystal display of claim 11, further comprising a second passivation layer formed below the first passivation layer.

13. A method of manufacturing a liquid crystal display, comprising:
forming gate lines on a substrate;
sequentially forming a gate insulating layer and a semiconductor layer on the gate lines;
forming data lines on the semiconductor layer;
forming a first passivation layer on the data lines;
forming a transparent electrode on the first passivation layer;
forming a reflecting electrode on the transparent electrode;
forming a photosensitive film on the reflecting electrode;
disposing a printing plate having a plurality of protrusions above the photosensitive film;
removing portions of the photosensitive film corresponding to the protrusions by imprinting the photosensitive film with the printing plate; and
etching the reflecting electrode by using the photosensitive film as a mask.

14. The method of claim 13, wherein the forming of the first passivation layer includes:
forming a photosensitive organic film; and
forming the surface of the photosensitive organic film in an uneven shape having a first concave portion, a second convex portion, and a third portion located between the first portion and the second portion.

15. The method of claim 14, wherein, in the disposing of the printing plate, the protrusion of the printing plate is disposed so as to correspond to the third portion of the first passivation layer.

16. The method of claim 13, wherein the protrusion of the printing plate has the width in the range of about 1 μm to 1.5 μm.

17. The method of claim 13, further comprising forming a second passivation layer before the forming of the first passivation layer.

18. The method of claim 13,
wherein the removing portions of the photosensitive film corresponding to the protrusions includes at least one of thermosetting and photo-curing the photosensitive film.
